(19) United States
(12) Patent Application Publication
(10) Pub. No.: US 2008/0245722 A1
(43) Pub. Date: Oct. 9, 2008

(54) WASTEWATER FILTERING APPARATUS

(75) Inventors: Hiroshi Koike, Tokyo (JP); Takashi Suzuki, Tokyo (JP); Susumu Nagai, Tokyo (JP); Takeshi Masaki, Tochigi (JP); Hisamatsu Muto, Gifu (JP)

Correspondence Address: STANDLEY LAW GROUP LLP, 495 METRO PLACE SOUTH, SUITE 210, DUBLIN, OH, 43017, US

(73) Assignees: HONDA MOTOR CO., LTD., Tokyo (JP); GE TECHNO CO., LTD, Gifu (JP)

(21) Appl. No.: 12/062,977

(22) Filed: Apr. 4, 2008

(30) Foreign Application Priority Data
Apr. 5, 2007 (JP) 2007-099477
Feb. 1, 2008 (JP) 2008-022946

(51) Int. Cl. B01D 29/00

(52) U.S. Cl. 210/266; 210/323.2; 210/333.1

(57) ABSTRACT

A filtration apparatus including a tubular element (17) for purifying wastewater that flows from outside to inside, and a spray tube (21) for spraying cleaning water onto the external peripheral surface of the tubular element. In the first step, the external peripheral surface of the tubular element is cleaned and most of solid matter is removed. In the second step, compressed air is fed to the tubular element, and fine solid matter that is embedded in the filter is removed by backwashing.

### FIELD OF THE INVENTION

The present invention relates to a technique for filtering wastewater in which solid components are mixed.

### BACKGROUND OF THE INVENTION

A filtering apparatus is an important tool in making effective use of water resources. This is because wastewater can be converted to purified water by a filtering apparatus. An essential component of a filtering apparatus is an element for removing impurities that include solid matter from wastewater. The amount of solid matter that accumulates in the element is proportional to the time elapsed in filtering. Flow resistance increases when the amount of sediment increases, and the amount of water that can be treated is reduced. In order to restore the amount of water that can be treated, the element must be replaced with a new element or the element must be regenerated.

Considering the effective use of earth resources, regeneration is more preferable to replacing elements. A technique for regenerating elements is described in, e.g., Japanese Patent Application Laid-Open Publication No. 2001-108790 (JP 2001-108790 A). The filtering and regenerating technique described in JP 2001-108790 A is described with reference to FIGS. 8A to 8C hereof.

Solid matter in the wastewater flows (arrow B) from an outer surface 101 of an element 100 toward an inner surface 102 when the wastewater flows in the manner indicated by arrow A parallel to the element 100, which is composed of a ceramic filter, as shown in FIG. 8A. In this case, solid matter 103 accumulates on the outer surface 101 of the element 100. Wastewater is purified in this manner.

Water pressure P1 is applied from the inner surface of 102 toward the outer surface 101 when a fixed amount of wastewater is treated, as shown in FIG. 8B. On the other hand, a water pressure P2, which is a lower pressure than water pressure P1, is applied from the outer surface 101 toward the inner surface 102.

Next, the water pressure P2 is rapidly reduced. At this point, the solid matter 103 that is deposited on the outer surface 101 is removed by the effect of the water pressure P1, as described in FIG. 8C. The element 100 is thereby regenerated.

Regeneration is smoothly carried out because sludge is soft when the solid matter 103 is principally composed of sludge.

However, in the case that sand and fine metals are mixed in large quantities in the solid matter 103, a substance is formed in which the sand or the like in the sludge is embedded as an aggregate and becomes hard overall, and the removal of the solid matter 103 becomes difficult. The difficulty particularly increases when the thickness of the sediments increases. The regeneration described above is not suitable for wastewater that contains large amounts of sand and the like.

In view of the above, there is a need for a filtration technology that is advantageous for treating wastewater containing large amounts of sand and the like.

### SUMMARY OF THE INVENTION

In the discussion below, the term “backwashing” is short for “backflow washing.” Backflow washing refers to washing by sending a fluid in an opposite direction of the filtration flow. Also, the term “regeneration” refers to removal of impurities from an element and the regeneration of the element.

According to the present invention, there is provided a wastewater filtering apparatus for filtering wastewater in which solid matter is mixed, the apparatus comprising a container for storing the wastewater; a wastewater inlet tube that is connected to the container and that directs wastewater into the container; a tubular element that is disposed inside the container and that removes impurities containing the solid matter from wastewater that flows from an outside to an inside; a purified water transport tube for drawing out filtered purified water to the exterior of the container; a cleaning water spray tube that is disposed inside the container and that sprays cleaning water to an outside surface of the tubular element; a rotation mechanism for rotating the tubular element when the cleaning water is sprayed, and causing the outside surface of the tubular element to be uniformly aligned facing the cleaning water spray tube; a backflow supply tube for supplying fluid to the inside of the tubular element after the rotation by the rotation mechanism has been stopped, and washing the tubular element using the backflow; and a deposit transport tube which extends from a bottom of the container and whereby the impurities containing the solid matter that has been removed by the cleaning water and the fluid are discharged from the container.

There is an advantage in that the external peripheral surface of the tubular element is cleaned and most of the solid matter is removed in the first step, even fine solid matter that has been embedded on the filter in the second step can be removed by backwashing, and highly precise regeneration can be achieved. As a result, wastewater that contains large amounts of sand and the like can be treated.

Preferably, a plurality of the tubular elements is disposed about a periphery of the cleaning water spray tube. There is an advantage in that a plurality of the tubular elements can be cleaned by using a single purified water spray tube.

Desirably, the purified water transport tube is provided with an activated charcoal filter that further filters the filtered purified water. Very fine sand and the like that cannot be filtered by the tubular element can be reliably filtered. Filtration precision increases.

In a preferred form, the fluid for the backwashing be compressed air. The cleaning of the first step is performed using water, and most of the impurities are removed. The cleaning of the second step is adequately performed using compressed air. In accordance with the present invention, water can be conserved in comparison with the case in which water is used in the first and second steps.

### BRIEF DESCRIPTION OF THE DRAWINGS

A preferred embodiment of the present invention will be described in detail below, by way of example only, with reference to the accompanying drawings, in which:

FIG. 1 is a cross-sectional view of a wastewater filtering apparatus according to the present invention;

FIG. 2 is a cross-sectional view taken along line 2-2 of FIG. 1;

FIG. 3 is a schematic view illustrating an ordinary filtrating operation;

FIG. 4 is a schematic view illustrating a first step of a regeneration operation;

FIG. 5 is a schematic view illustrating a second step of the regeneration operation;

FIG. 6 is a flowchart of the filtration operation and regeneration operation;

FIG. 7 is a diagrammatical view illustrating a basic theory of a workpiece cleaning machine provided with the filtering apparatus; and

FIGS. 8A to 8C are diagrammatical views illustrating conventional filtration and regeneration operations.

### DETAILED DESCRIPTION OF THE PREFERRED EMBODIMENT

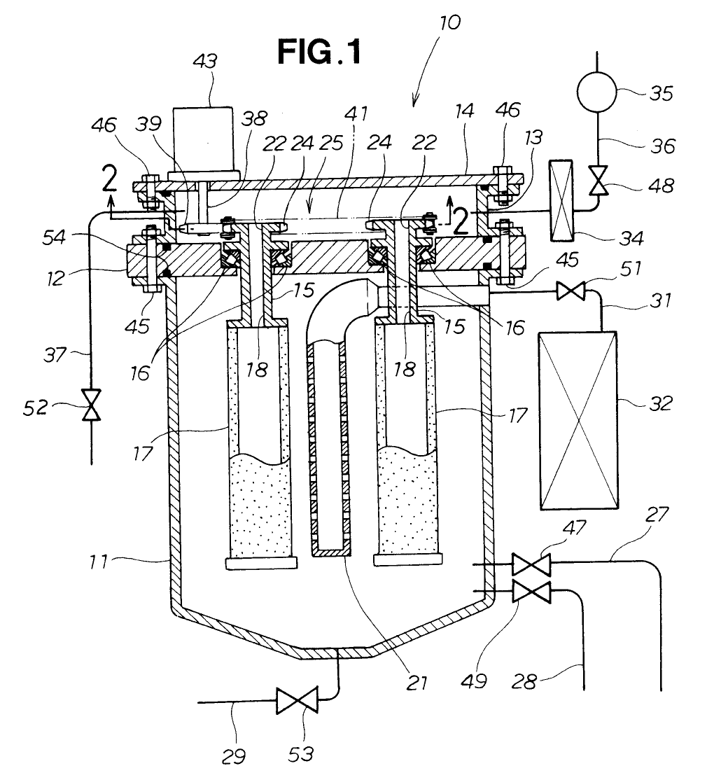

As shown in FIG. 1, the filtering apparatus 10 is comprised of a container 11 that is opens at the top, an intermediate plate 12 that is disposed in an upper portion of the container 11 so as to close off the container 11, a cylinder 13 that is superimposed on the intermediate plate 12, a cover 14 that is superimposed on the cylinder 13 and acts as a cover of the cylinder 13, a hollow body 15 that passes completely through the intermediate plate 12 in the vertical direction and that is rotatably supported by the intermediate plate 12 via a bearing 16, a sprocket 24 provided to the top end of the hollow body 15, a tubular element 17 that is supported at the lower end of the hollow body 15 and that extends in the perpendicular direction into the container 11, a passage 18 that is disposed inside the hollow body 15 and that connects the inner part of the tubular element 17 and the inner part of the cylinder 13, a cleaning water spray tube 21 that is disposed in the container 11 and that is vertically placed between a plurality of tubular elements 17, a rotation mechanism 25 that rotates the sprocket 24, a wastewater inlet tube 27 that is provided to the side surface of the lower portion of the container 11 and that introduces wastewater into the container 11, a wastewater discharge tube 28 that is provided to the outer surface of the lower portion of container 11 and that is used for discharging wastewater from inside the container 11, a deposit transport tube 29 that is provided to the bottom surface of container 11 and that is used for transporting to the exterior solid matter that has been removed by cleaning, a purified water tank 32 that is connected to the cleaning water spray tube 21 via a cleaning water inlet tube 31, an activated charcoal filter 34 that is provided to the exterior of the cylinder 13 and that is used for further filtering the filtered water, a flowmeter 35 that is disposed in the vicinity of the activated charcoal filter 34 and that is used for measuring the flow rate of the filtered water, a purified water transport tube 36 in which the distal end is connected to the cylinder 13 and which contains the activated charcoal filter 34 and the flowmeter 35, and a backflow supply tube 37 in which the distal end is connected to the cylinder 13 separately from the purified water transport tube 36 and which supplies compressed air inside the cylinder 13.

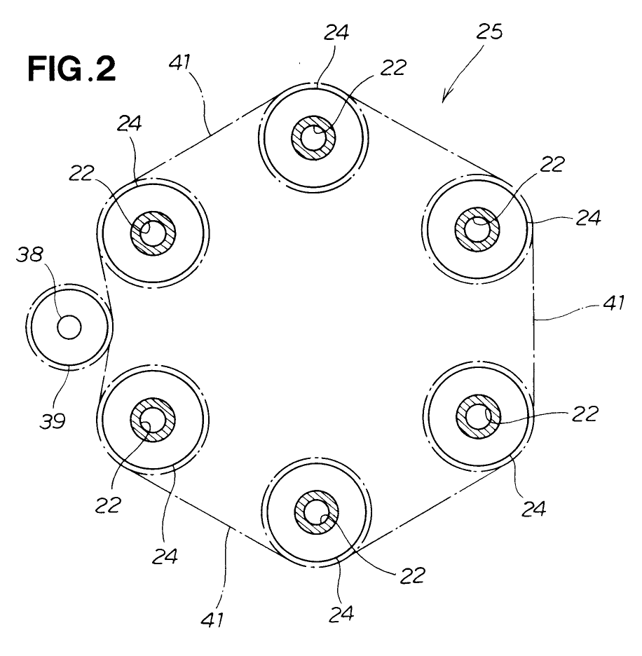

The rotation mechanism 25 has a rotating shaft 38 that extends in the front/rear direction of the diagram, a rotating shaft sprocket 39 provided to the rotating shaft 38, and a chain 41 that is disposed so as to make contact with rotating shaft sprocket 39 and the sprocket 24 and that drives the sprocket 24, as shown in FIG. 2.

A motor 43 for driving the rotation mechanism 25 is provided to the upper portion of the cover 14, as shown in FIG. 1. The upper surface of the container 11, the lower surface of the intermediate plate 12, and the cylinder 13 are connected by a long bolt 45, and the cylinder 13 and the cover 14 are connected by a short bolt 46. Reference numerals 47, 48, 49, 51, 52, and 53 are valves that open and close the tubes, and 54 is a sealing material, preferably an O-ring.

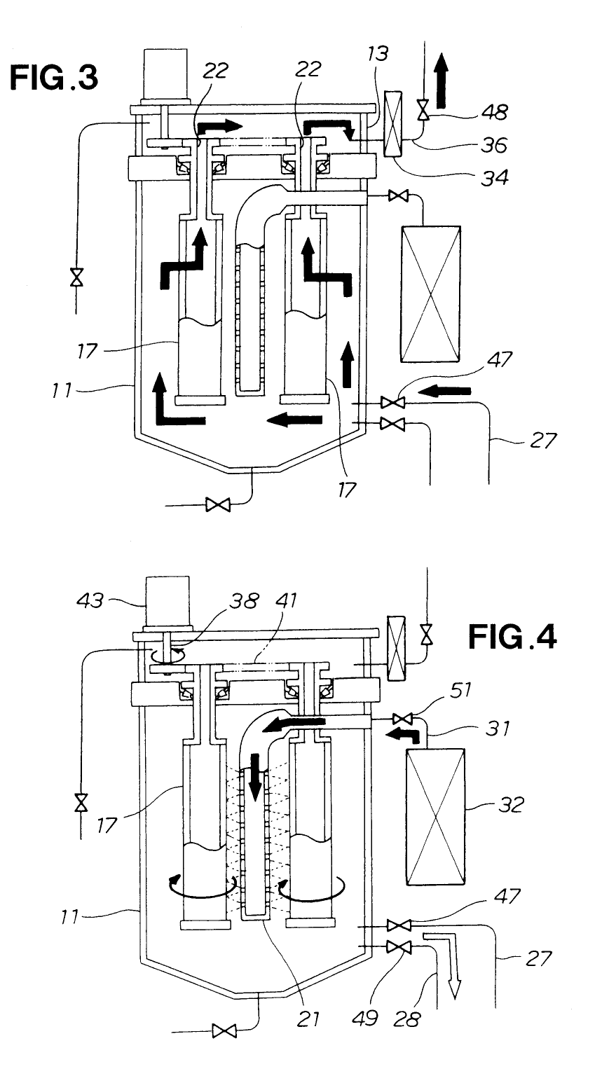

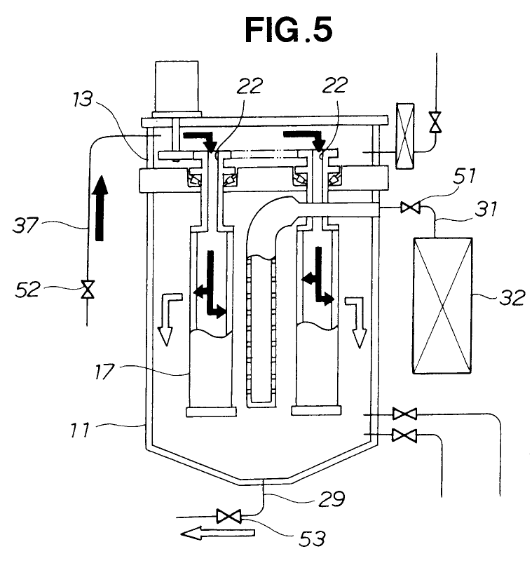

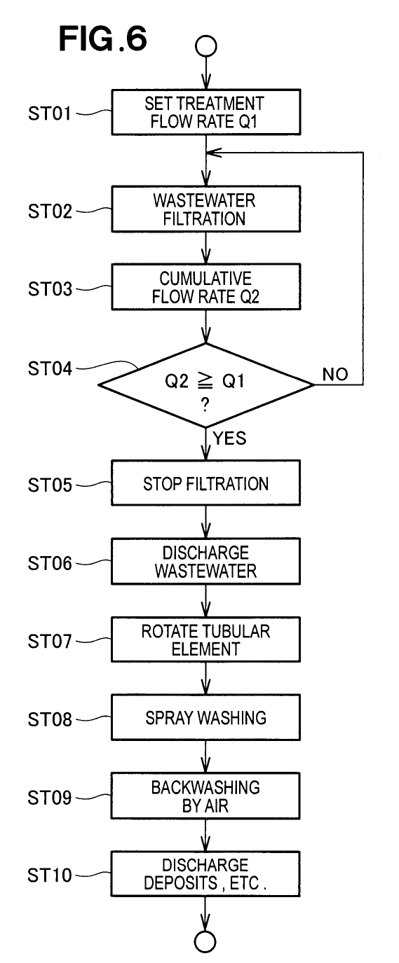

The effect of the filtering apparatus having the configuration described above will be described next. In other words, an ordinary filtration operation will be described with reference to FIG. 3, the operation of the first step of regeneration will be described with reference to FIG. 4, the operation of the second step of regeneration will be described with reference to FIG. 5, and the overall flow of the operation will be described with reference to FIG. 6. Furthermore, the dark arrows in FIGS. 3 to 5 indicate the flow of water, and white arrows indicate the flow of air.

The wastewater introduced from the wastewater inlet tube 27 into the container 11 flows from the external peripheral surface toward the internal peripheral surface of the tubular element 17, and the filtration of the first step is performed by the tubular element 17, as described in FIG. 3. Purified water thus filtered flows from a purified water outlet 22 to the cylinder 13 and passes through the purified water transport tube 36, and the filtration of the second step is performed by the activated charcoal filter 34.

Very fine sand and the like that could not be filtered by the tubular element 17 can be reliably filtered. Filtration precision increases.

Purified water that has been purified by the tubular element 17 and the activated charcoal filter 34 in the second step can thereby be obtained in a continuous fashion. However, sand and other solid matter that was contained in wastewater accumulates on the external peripheral surface of the tubular element 17 when the purification operation progresses, and filtration capacity is reduced. In view of the above, the regenerating operation is suitably carried out in the following manner.

First, the wastewater inlet valve 47 is closed in the first step of regeneration, and the introduction of wastewater to the container 11 is stopped, as shown in FIG. 4. Next, the wastewater discharge valve 49 is opened. Wastewater collected in the container 11 can thereby be discharged to the exterior as indicated by the white arrow at bottom right of the diagram.

When the discharge of wastewater is completed, the wastewater discharge valve 49 is closed, the motor 43 is actuated as indicated by the arrows, and the tubular element 17 is rotated. The cleaning water inlet valve 51 is opened at the same time. At this point, the cleaning water can be sent from the purified water tank 32 to the cleaning water spray tube 21 as indicated by the black arrows. The cleaning water is sprayed from the cleaning water spray tube 21 toward the external peripheral surface of the tubular element 17, and the deposits of tubular element 17 are cleaned in the manner indicated by the imaginary lines.

The large portion of solid matter accumulated on the external peripheral surface of the tubular element 17 can be removed by the cleaning water. The sediments in which sand and fine metals have become mixed in the sludge and hardened can be particularly effectively removed by the water pressure of the cleaning water.

Furthermore, since the tubular element 17 is rotated at a fixed speed by the motor 43, the cleaning water indicated by the imaginary lines uniformly makes contact with the entire periphery of the tubular element 17, and unclean areas do not occur. In other words, a plurality (e.g., six) of the tubular elements 17 can be cleaned in a single process by using a single cleaning water tube 21.

The cleaning water inlet valve 51 closes and cleaning by the purified water is ended when the cleaning is performed by the cleaning water spray tube 21 for a fixed length of time.

Next, in the second step of regeneration, the cleaning water inlet valve 51 is first closed, as shown in FIG. 5. Next, the backflow inlet valve 52 is opened and compressed air is sent from the backflow supply tube 37 to the cylinder 13 as indicated by the black arrows. The compressed air sent into the cylinder 13 passes through the purified water outlet 22 and flows from the internal peripheral surface of the tubular element 17 towards the external peripheral surface.

The solid matter that is deposited on the external peripheral surface of the tubular element 17 is blown to the exterior by compressed air as indicated by the white arrows. The cleaning capacity is low because the density of air is less than that of water. However, in the present invention, the quantity of remaining deposits is low and the thickness of the layer is also low because a large portion of the sediments has been cleaned away in the first step of the regeneration operation. For this reason, cleaning is possible even using compressed air in the second step.

The cleaning of the second step can be performed using cleaning water, but the quantity of cleaning water that is used can be reduced when compressed air is used as in the present invention.

The backflow inlet valve 52 is closed and the backflow produced by the compressed air is ended after the backflow produced by the compressed air is carried out for a fixed length of time.

Next, the deposit transport valve 53 is opened. Solid matter collected in the bottom portion of the container 11 and the cleaning water used in the first step are thereby sent from the deposit transport tube 29 to the exterior as indicated by the white arrow in the lower portion of the diagram, and the cleaning of the tubular element 17 is ended.

Next, the overall operation of FIGS. 3 to 5 described above will be described with reference to FIG. 6.

A treatment flow rate Q1 is set in step (hereinafter abbreviated as ST) 01 in the manner shown in FIG. 6. The wastewater is introduced into the wastewater tank and filtered by the tubular element (ST02). The cumulative flow rate Q2 is measured in this interval (ST03). Specifically, the flow rate of filtered water is measured by the flowmeter 35 shown in FIG. 1.

The cumulative flow rate Q2 is examined as to whether the treatment flow rate Q1 has been reached (ST04). If the cumulative flow rate is less than Q1, the filtration of wastewater (ST02) continues, and the filtration stops when Q1 is reached (ST05). Specifically, the wastewater inlet valve 47 shown in FIG. 1 is closed.

Wastewater inside the wastewater tank is discharged from the wastewater discharge outlet (ST06).

The tubular element is rotated (ST07), purified water is sprayed onto the external peripheral surface of the tubular element that is being rotated, and the tubular element is washed (ST08).

The tubular element is backwashed by compressed air (ST09).

The deposits collected in the lower portion of the wastewater tank and the purified water sprayed in ST08 are discharged to the exterior of the wastewater tank (ST10).

The filtration apparatus 10 described above can be provided to a variety of applications. An example in which the filtration apparatus is applied to a workpiece washing apparatus will be described below.

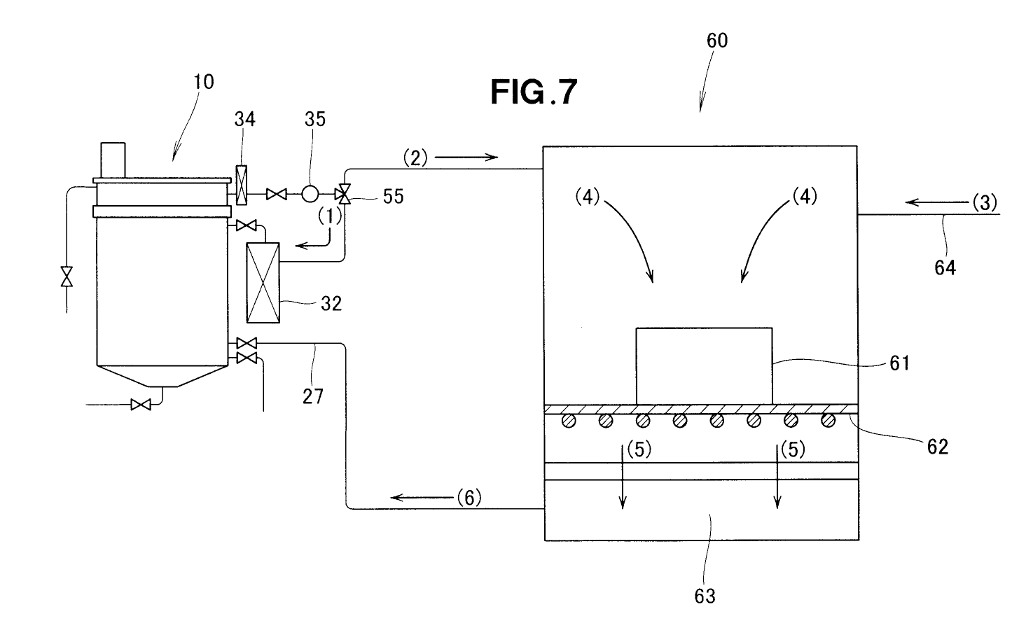

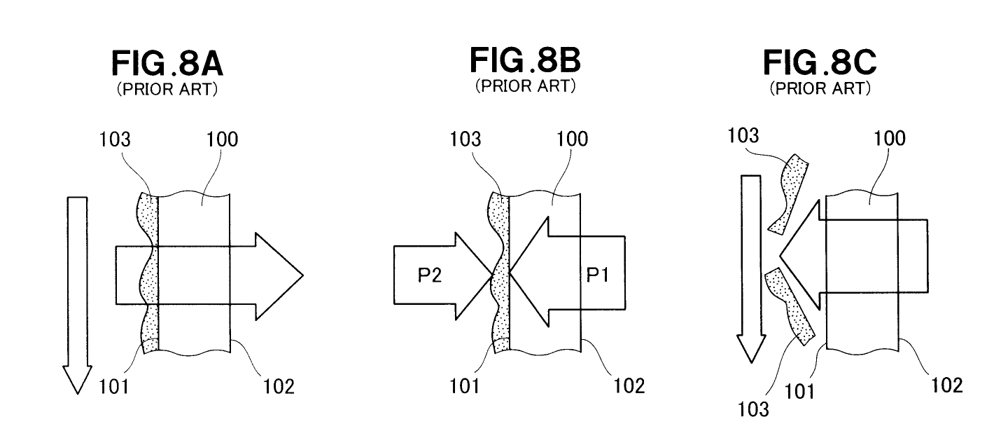

A workpiece washing apparatus 60 includes a reticulated workpiece mount 62 on which a workpiece 61 to be washed is mounted, and a wastewater tank 63 for receiving the wastewater generated when the workpiece 61 is washed, as shown in FIG. 7.

One opening of a three-way valve 55 is connected to the flowmeter 35, one of the remaining openings of the three-way valve 55 is connected to the purified water tank 32, and the remaining opening is connected to the workpiece cleaning apparatus 60.

The purified water filtered through the filtration apparatus 10 is allowed to flow to the purified water tank 32 until a prescribed quantity is collected in the manner indicated by arrow (1). The three-way valve 55 is switched when the prescribed quantity of purified water is collected in the purified water tank 32. The purified water is then sent to the workpiece cleaning apparatus 60 when the three-way valve 55 switches in the manner indicated by arrow (2).

The workpiece 61 is cleaned in the manner indicated by the arrow (4) by purified water sent to the workpiece cleaning apparatus 60, and purified water is introduced from a workpiece cleaning water inlet tube 64 in the manner indicated by arrow (3). Sand and the like that have been deposited on the workpiece 61 by cleaning the workpiece 61 is made to fall into the wastewater tank 63 together with water in the manner indicated by arrow (5).

The wastewater collected in the wastewater tank 63 passes through the wastewater inlet tube 27 in the manner indicated by arrow (6), and is introduced into the filtration apparatus 10. The wastewater thus introduced is filtered inside the filtration apparatus 10, and steps (1) through (6) are repeated.

Wastewater is not required to be discarded and a contribution is made to environmental conservation because purified water that has been filtered is used to wash the workpiece 61. The quantity of purified water introduced from the workpiece cleaning inlet tube 64 can be reduced. In addition, purified water obtained by filtration is made to flow into the purified water tank, and the element is regenerated using purified water. The quantity of purified water introduced from the exterior can be reduced, as can running costs of using the filtration apparatus.

Obviously, various minor changes and modifications of the present invention are possible in light of the above teaching. It is therefore to be understood that within the scope of the appended claims the invention may be practiced otherwise than as specifically described.

What is claimed is:

1. A wastewater filtering apparatus for filtering wastewater in which solid matter is mixed, the apparatus comprising:
a container for storing the wastewater;
a wastewater inlet tube connected to the container for directing wastewater into the container;
a tubular element disposed inside the container for removing impurities containing the solid matter from wastewater that flows from an outside to an inside;
a purified water transport tube for drawing out filtered purified water to an exterior of the container;
a cleaning water spray tube disposed inside the container for spraying cleaning water to an outside surface of the tubular element;
a rotation mechanism for rotating the tubular element when the cleaning water is sprayed and causing the outside surface of the tubular element to be uniformly aligned facing the cleaning water spray tube;
a backflow supply tube for supplying fluid to an inside of the tubular element after rotation by the rotation mechanism is stopped and washing the tubular element using the backflow; and
a deposit transport tube extending from a bottom of the container for discharging from the container the impurities containing the solid matter removed by the cleaning water and the fluid.

2. The wastewater filtering apparatus of claim 1, wherein a plurality of the tubular elements is disposed about a periphery of the cleaning water spray tube.

3. The wastewater filtering apparatus of claim 1, wherein the purified water transport tube is provided with an activated charcoal filter that further filters the filtered purified water.

4. The wastewater filtering apparatus of claim 1, wherein the fluid for the backwashing is compressed air.
